(19) United States
(12) Patent Application Publication
(10) Pub. No.: US 2016/0326399 A1
(43) Pub. Date: Nov. 10, 2016

(54) HIGHLY HEAT-RESISTANT COMPOSITE MATERIAL WITH EXCELLENT FORMABILITY AND PRODUCTION METHOD THEREOF

(71) Applicants: HYUNDAI MOTOR COMPANY, Seoul (KR); KIA MOTORS CORPORATION, Seoul (KR); TORAY CHEMICAL KOREA INC., Gumi-si (KR); AUTOMOBILE INDUSTRIAL ACE, Ansan-si (KR)

(72) Inventors: Hyun Gyun Kim, Hwaseong, Gyeonggi-do (KR); Dong Eun Cha, Suwon, Gyeonggi-do (KR); Seung Mok Lee, Osan, Gyeonggi-do (KR); Jin Young Yoon, Gimpo, Gyeonggi-do (KR); Seong Hwan Lee, Ansan, Gyeonggi-do (KR); Chi Hun Kim, Yongin, Gyeonggi-Do (KR); Ja Jeong Koo, Daegu (KR); Hyo Seok Kim, Namyangju, Gyeonggi-Do (KR)

(73) Assignees: Hyundai Motor Company, Seoul (KR); Kia Motors Corporation, Seoul (KR); Toray Chemical Korea Inc., Gumi, Geongsangbuk-Do (KR); Automobile Industrial Ace, Ansan, Gyeonggi-Do (KR)

(21) Appl. No.: 15/109,563

(22) PCT Filed: Dec. 31, 2014
(86) PCT No.: PCT/KR2014/013127

§ 371 Date: Jul. 1, 2016

(30) Foreign Application Priority Data
Jan. 3, 2014 (KR) 10-2014-0000864
Dec. 31, 2014 (KR) 10-2014-0195113

(51) Int. Cl. C09D 177/10; C08J 7/04

(52) U.S. Cl. CPC C09D 177/10; C08J 7/047; C08J 2377/10; C08J 2477/10

(57) ABSTRACT

A novel composite material which can replace a conventionally used metal material and includes an aramid composite, a production method thereof, and use of the composite material as an alternative to heavy metal materials which have been used as component materials for cars, airplanes, ships, electrical and electronic products, particularly as an alternative material for car tail trims, based on reduced weight, high heat resistance and superior formability thereof, are provided.

### CROSS-REFERENCE TO RELATED APPLICATION

This application claims under 35 U.S.C. §119(a) the benefit of priority to Korean Patent Application Nos. 10-2014-0000864 and 10-2014-0195113 filed on Jan. 3, 2014; Dec. 31, 2014, respectively, the entire contents of which are incorporated herein by reference.

### BACKGROUND

(a) Technical Field

The present invention relates to a novel composite material which can replace a conventionally used metal material and includes an aramid composite, a production method thereof, and use of the composite material as a material for car tail trims based on reduced weight, high heat resistance and superior formability thereof.

(b) Background Art

In general, polyamide-based synthetic resins are classified into aliphatic polyamide and aromatic polyamide. Aliphatic polyamide is commonly referred to as the trade name “nylon” and aromatic polyamide is commonly referred to as the trade name “aramid”.

Of the aliphatic polyamides, nylon 6, nylon 6,6 and the like are used as the most general thermoplastic engineering plastic materials and are utilized in the fields including a variety of molding materials as well as fibers. Nylon resins used in the molding are produced into reinforced plastics by reinforcement with mineral or glass fibers in order to improve flame retardancy and impact resistance, reduce the price and enhance mechanical properties such as elasticity.

Aromatic polyamide so-called “aramid” developed in the 1960s for improving heat resistance of nylon which is an aliphatic polyamide and is well-known by the trade names such as NOMEX® and KEVLAR®. These aromatic polyamide materials have superior heat resistance and high tensile strength enough to be utilized in fiber applications such as flame retardant fiber fabrics and tire cords.

General aliphatic polyamide refers to a synthetic resin which contains aliphatic hydrocarbon bound between amide groups or a synthetic resin which contains 85% or greater of an aromatic ring such as a benzene ring between aramid groups. The aliphatic hydrocarbon of the aliphatic polyamide readily undergoes molecular motion when heat is applied thereto. Meanwhile, the benzene ring of aromatic polyamide does not readily move molecules even upon application of heat due to rigid molecular chains, and thus has great differences from general aliphatic polyamide because of heat stability and high elasticity.

Aromatic polyamides are classified into para-aramid and meta-aramid.

A representative example of para-aramid is KEVLAR® developed by Dupont. Para-aramid is an aramid in which a benzene ring bonds to an amide group at a para-position, which has very rigid molecular chains, has very excellent strength due to filiform structure and is highly capable of absorbing impact owing to high elasticity. Para-aramid has been used for bulletproof garments, bulletproof helmets, safety gloves or boots and fire fighting garments, for sports equipment materials such as tennis rackets, boats, hockey sticks, fishing lines and golf clubs, and for industrial applications such as fiber reinforced plastics (FRP) and asbestos replacement fibers.

Representative examples of meta-aramid are NOMEX® developed by DuPont and CONEX® developed by Teijin. Meta-aramid is an aramid in which a benzene ring is bonded to an amide group at a meta-position, which has similar strength and elongation to normal nylons, but has advantageously considerably high heat stability and low weight, and somewhat absorbs sweat, thus being fresh and pleasant as compared to other heat-resistant materials. At an early stage, meta-aramid was limited to only some colors, whereas at present, meta-aramid with a variety of colors including fluorescent color has been produced. Meta-aramid has been used for fire fighting garments, uniforms for racing drivers, astronaut uniforms and heat-resistant garment materials such as working clothes and industrial applications such as high-temperature filters.

Meanwhile, metallic vehicle materials (Korean Patent No. 10-0723630) have been conventionally used as vehicle materials, but these have a problem of low vehicle running fuel efficiency due to high weight.

In this regard, members containing glass fibers as main components, such as blends of polyethylene or polypropylene sheets with glass fibers, laminates of blends of natural fibers such as polypropylene fiber or hemp with glass fibers by needle punching, or polyurethane foams having glass fiber sheets bonded to opposite surfaces thereof, have been used as vehicle materials. The members using the glass fibers have excellent dimensional stability, rigidity and heat resistance, but have had problems associated with forming workability, eco-friendliness and recycling applicability (Korean Patent Laid-open No. 10-2006-0045364).

As another method, there have been some products using plastic composite materials with excellent rigidity or bubble sheets, or corrugated sheets or blow-structure lightweight plate materials such as blow-molded panels as base layers. However, when only the materials are applied to interior materials for vehicles such as luggage covers requiring high rigidity, desired rigidity cannot be satisfied and plates as finished products may be bent or broken upon use and cannot be used any more. In particular, although a plate material in which a plastic sheet is laminated and/or bonded in a predetermined thickness outside the base layer is intended to be designed using a bubble sheet, a corrugated sheet, or a blow-molded panel, including a space and a separator, as a base layer, when laminating and/or bonding the plastic sheet to an upper and/or lower part of the base layer, the upper and/or lower part of the plastic sheet is depressed inside the space due to the space of the base layer and many problems such as rough (irregular) adhesion or detachment upon use and thus unavailability occurs (Korean Patent No. 10-0779266).

In addition, vehicle materials containing a toxic compound such as phenol resin have had a problem of causing environmental contamination.

Thus, there is an urgent need for developing new materials which can replace metal materials.

### PRIOR ART DOCUMENT

### Patent Document

(Patent Document 1) Korean Patent No. 10-0723630

(Patent Document 2) Korean Patent Laid-open No. 10-2006-0045364

(Patent Document 3) Korean Patent No. 10-0779266

### SUMMARY OF THE DISCLOSURE

Accordingly, as a result of research to develop highly heat-resistant plastic materials which can replace conventional metal components, the inventors of the present invention found plastic materials with excellent heat resistance and strength and thus the present invention has been completed based on this finding.

An object of the present invention is to provide a novel composite material including an aramid composite which can replace a conventionally used metal material, a production method thereof, and use of the composite material as a material for car tail trims.

In one aspect, the present invention provides a highly heat-resistant composite material including an aramid fabric; and a coating layer coating partially or entirely the aramid fabric, wherein the coating layer is a cured layer of a coating agent including an aramid polymer having a repeat unit represented by the following Formula 2:

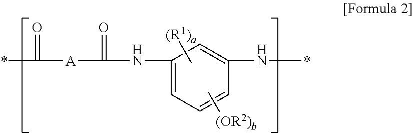

wherein A is

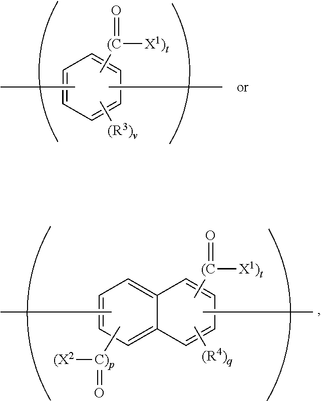

R¹ and R² are each independently a C1-C5 alkyl group, R³ and R⁴ are each independently a hydrogen atom or a C1-C4 alkyl group, X¹ and X² are each independently —F, —Cl, —Br or —I, and a, b, p, q, t and v are each independently an integer of 0 to 2.

In a preferred embodiment, A is

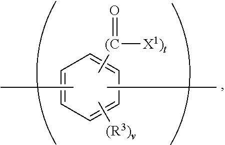

wherein R³ is a hydrogen atom or a C1-C2 alkyl group, X¹ is —F, —Cl, —Br or —I, and t and v are each independently an integer of 0 to 1.

In a preferred embodiment, the aramid polymer may have a weight average molecular weight of 5,000 to 500,000.

In a preferred embodiment, the coating agent may further include 0.1 to 20 parts by weight of an inorganic substance, with respect to 100 parts by weight of the aramid polymer.

In a preferred embodiment, the inorganic substance may include one or more selected from the group consisting of glass fiber, SiO₂, TiO₂, graphene, carbon nanotube (CNT), carbon black and nanoclay.

In a preferred embodiment, the coating agent may further include one or more solvents selected from the group consisting of N-methyl-2-pyrrolidone, dimethylformamide, dimethyl sulfide and dimethylacetamide.

In a preferred embodiment, the highly heat-resistant composite material may have an average thickness of 1,000 to 2,000 μm.

In another aspect, the present invention provides a method for producing a highly heat-resistant composite material including: preparing an aramid monomer represented by the following Formula 2 by coupling one or more aromatic diamines represented by the following Formula 1 and aromatic diacid chloride in the presence of a catalyst including one or more selected from calcium chloride and lithium chloride, and a solvent; and preparing a crude aramid liquid containing an aramid polymer and the solvent by stirring the aramid monomer and the solvent to prepare a mixture and conducting sol-gel reaction of the mixture at a temperature of 0° C. to 40° C. under the atmosphere of nitrogen (N₂).

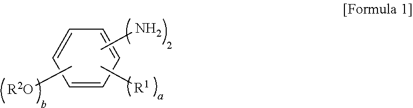

wherein R¹ and R² are each independently a C1-C5 alkyl group, and a and b are each independently an integer of 0 to 2, and

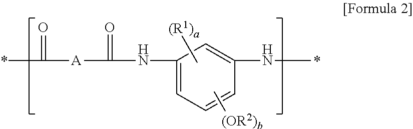

wherein A is each independently

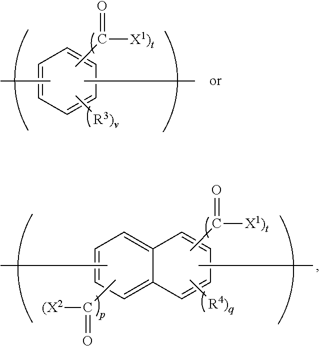

R¹ and R² are each independently a C1-C5 alkyl group, R³ and R⁴ are each independently a hydrogen atom or a C1-C4 alkyl group, X¹ and X² are each independently —F, —Cl, —Br or —I, and a, b, p, q, t and v are each independently an integer of 0 to 2.

In a preferred embodiment, the method may further include coating partially or entirely the aramid fabric with the crude aramid liquid, laminating and pressing the crude aramid liquid-coated aramid fabric, and drying the resulting aramid fabric.

In a preferred embodiment, the aromatic diacid chloride may include one or more selected from the group consisting of trimesoyl chloride, naphthalene-2,7-dicarbonyl chloride, naphthalene-2,6-dicarbonyl chloride, isophthaloyl chloride and terephthaloyl chloride.

In a preferred embodiment, the solvent for preparation of the aramid monomer and preparation of the crude aramid liquid may independently include one or more selected from the group consisting of N-methyl-2-pyrrolidone, dimethylformamide, dimethyl sulfide and dimethylacetamide.

In a preferred embodiment, the aromatic diacid chloride may be present in an amount of 95 to 105 parts by weight and the catalyst may be present in an amount of 1 to 10 parts by weight, with respect to 100 parts by weight of the aromatic diamine.

In a preferred embodiment, the mixture during sol-gel reaction may include 400 to 1,900 parts by weight of the solvent, with respect to 100 parts by weight of the aramid polymer.

In a preferred embodiment, the mixture during sol-gel reaction may further include 0.1 to 20 parts by weight of an inorganic substance, with respect to 100 parts by weight of the aramid polymer.

In a preferred embodiment, the inorganic substance may include one or more selected from the group consisting of glass fiber, SiO₂, TiO₂, graphene, carbon nanotube (CNT), carbon black and nanoclay.

In another aspect, the present invention provides a car tail trim including the highly heat-resistant composite material.

The highly heat-resistant composite material according to the present invention is not deformed at high temperatures and has excellent strength as well as superior formability and is thus advantageously useful as lightweight materials which can replace conventional metal material components.

As a result, the highly heat-resistant composite material according to the present invention is useful as an alternative to heavy metal materials which have been used as component materials for cars, airplanes, ships, electrical and electronic products and is particularly useful as a material for car tail trims.

The production method according to the present invention is simple and enables press forming with a lightweight material and thus has an effect of reducing process time.

### BRIEF DESCRIPTION OF THE DRAWINGS

FIG. 1 is a schematic view illustrating a cross-section of a highly heat-resistant composite material produced in Example 1.

### DETAILED DESCRIPTION

Throughout this specification, “in formula represented by

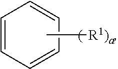

R¹ is independently a hydrogen atom, a methyl group or an ethyl group, and a is 1 to 3” may be described concerning a substituent. In this case, an expression “a is 3” means that a plurality of R¹, that is, three R¹ substituents are present. In addition, a plurality of R¹ may be identical or different. In other words, all of R¹ may be a hydrogen atom, a methyl group or an ethyl group, or R¹ are each different, that is, one of R¹ is a hydrogen atom, another one is a methyl group and the other is an ethyl group. In addition, the foregoing is an example for interpretation of substituents represented in the present invention and different forms of similar substituents should be also interpreted in the same manner as above.

Hereinafter, the present invention will be described in more detail.

The highly heat-resistant composite material according to the present invention can be produced by preparing an aramid monomer, preparing a crude aramid liquid by polymerizing the aramid monomer by sol-gel reaction, coating partially or entirely an aramid fabric with the crude aramid liquid, and conducting lamination, pressing and drying.

First, a method of preparing the crude aramid liquid will be described in detail. The crude aramid liquid is prepared by preparing an aramid monomer represented by the following Formula 2 which is prepared by coupling one or more aromatic diamines represented by the following formula 1 and aromatic diacid chloride under the presence of a catalyst including one or more selected from calcium chloride and lithium chloride, and a solvent; preparing a crude aramid liquid containing an aramid polymer and the solvent by stirring the aramid monomer and the solvent to prepare a mixture and conducting sol-gel reaction at a temperature of 0° C. to 40° C. under the atmosphere of nitrogen (N₂)

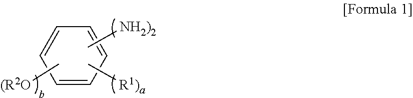

wherein R¹ and R² are each independently a C1-C5 alkyl group, preferably a C1-C2 alkyl group, and a and b are each independently an integer of 0 to 2, preferably an integer of 0 to 1. In addition, the aromatic diamine represented by Formula 1 is preferably meta-diamine.

The aromatic diacid chloride used for preparation of the aramid monomer functions to react with the aromatic diamine to constitute the aramid polymer. Any monomer for aramid polymers used in the art may be used as the aromatic diacid chloride without any limitation. The aromatic diacid chloride may preferably include one or more selected from the group consisting of trimesoyl chloride, naphthalene-2,7-dicarbonyl chloride, naphthalene-2,6-dicarbonyl chloride, isophthaloyl chloride and terephthaloyl chloride, more preferably isophthaloyl chloride and terephthaloyl chloride. In addition, the aromatic diacid chloride may be used in an amount of 95 to 105 parts by weight, preferably 98 to 102 parts by weight, with respect to 100 parts by weight of the aromatic diamine When the aromatic diacid chloride is used in an amount of less than 95 parts by weight, there may be problems of reduced yield and difficulty in securing sufficient molecular weights of polymers due to less solid content in the polymer. When the aromatic diacid chloride is used in an amount exceeding 105 parts by weight, there may be a problem of difficulty in obtaining homogeneous polymers.

In addition, in the preparation of the aramid monomer, the catalyst, the calcium chloride and/or lithium chloride functions to facilitate polymerization of the aromatic diamine and the aromatic diacid chloride. The catalyst may be used in an amount of 1 to 10 parts by weight, preferably 2 to 5 parts by weight, with respect to 100 parts by weight of the aromatic diamine. When the amount of used catalyst is less than 1 part by weight, an effect of improving solubility may be insufficient and when the amount of used catalyst exceeds 10 parts by weight, there may be a problem of less polymerization degree.

The method of preparing the crude aramid liquid may further include neutralizing hydrochloric acid produced as a by-product after sol-gel reaction.

Specifically, for example, as can be seen from the following Reaction Scheme 1, meta-phenylene diamine as aromatic diamine which can be used in the present invention reacts with terephthaloyl chloride (TPC) as aromatic diacid chloride to produce poly(metaphenylene isophthalamide) as a polymer and hydrochloric acid (HCl) as a by-product.

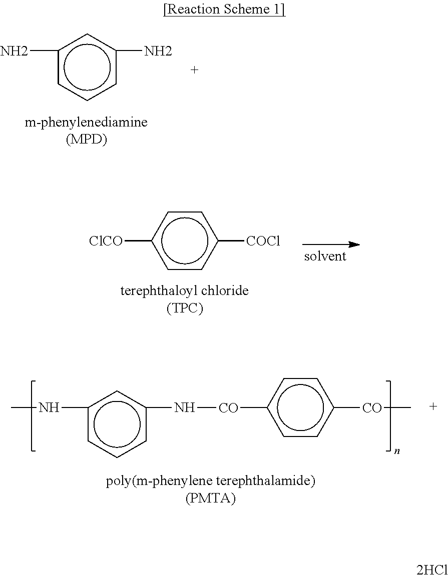

At this time, a step of neutralizing the obtained by-product, hydrochloric acid, is needed. This step is preferable for stability of the polymer composition. In this case, hydrochloric acid may be neutralized with a basic compound such as calcium hydroxide (Ca(OH)₂) or lithium hydroxide (LiOH) as a neutralizing agent, as shown in the following Reaction Scheme 2.

HCl+Ca(OH)₂→CaCl₂+2H₂O [Reaction Scheme 2]

The amount of added neutralizing agent during neutralization should be controlled according to the amount of used aromatic diamine or aromatic diacid chloride and is preferably equal to or 10% greater than the molar ratio of used aromatic diamine or aromatic diacid chloride.

In addition, the solvent used for preparation of the aramid monomer and preparation of the crude aramid liquid may be selected from solvents generally used in the art. The solvent preferably includes one or more selected from the group consisting of N-methyl-2-pyrrolidone, dimethylformamide, dimethyl sulfide and dimethylacetamide.

In addition, the produced crude aramid liquid includes an aramid polymer which is a reaction product polymerized by sol-gel reaction and a solvent. The solvent may be present in an amount of 400 to 1,900 parts by weight, preferably 800 to 1,200 parts by weight, with respect to 100 parts by weight of the aramid polymer. In this case, when the content of the solvent is less than 400 parts by weight, there may be a problem of difficulty in obtaining homogenous polymers and when the content of the solvent exceeds 1,900 parts by weight, there may be problems of lowered yield and difficulty in securing sufficient molecular weights of polymers due to less solid content in the polymer. Thus, the solvent is preferably used within the range defined above.

The sol-gel reaction is preferably carried out at a temperature of 0° C. to 40° C. When the sol-gel reaction is carried out at a temperature below 0° C., the yield of aramid polymer may be excessively reduced and when the sol-gel reaction is carried out at a temperature greater than 40° C., there may be a problem of low formability of the produced composite material due to high polymerization degree, and physical properties such as tensile strength of the composite material may deteriorate. Thus, sol-gel reaction is preferably carried out at a temperature defined above. In addition, the aramid polymer produced by sol-gel reaction has a weight average molecular weight of 5,000 to 500,000, preferably a weight average molecular weight of about 100,000 to about 300,000.

In addition, during the preparation of crude aramid liquid, an inorganic substance may be further added to the crude aramid liquid after sol-gel reaction in order to improve physical properties of highly heat-resistant composite material. The inorganic substance may be selected from inorganic substances generally used in the art and, for example, one or more inorganic substances selected from the group consisting of glass fiber, SiO₂, TiO₂, graphene, carbon nanotube (CNT), carbon black and nanoclay may be mixed with the crude aramid liquid. At this time, the amount of used inorganic substance may be 0.1 to 20 parts by weight, preferably 1 to 10 parts by weight, with respect to 100 parts by weight of the crude aramid liquid. In this case, when the amount of used inorganic substance is less than 0.1 parts by weight, an effect of improving physical properties may be insufficient due to excessively reduced used amount and when the amount of used inorganic substance exceeds 20 parts by weight, there may be problems of coating non-uniformity due to increased viscosity of crude aramid liquid and increased production costs. Thus, the inorganic substance is preferably used within the amount defined above.

In addition, in order to improve physical properties of highly heat-resistant composite material, an additive such as catalyst, flame retardant or thermal stabilizer generally used in the art, in addition to the inorganic substance, may be further added to the crude aramid liquid.

The highly heat-resistant composite material may be prepared by a process including coating partially or entirely the aramid fabric with the crude aramid liquid prepared by the method described above, laminating and pressing the crude aramid liquid-coated aramid fabric, and drying the same. In addition, the pressing may further include hot forming

During the coating, the coating may be selected from general methods used in the art such as impregnation or application and any method may be used such that the crude aramid liquid can be sufficiently coated inside and/or outside of the aramid fabric.

The aramid fabric may use, as a material, a polymer obtained by polymerization of one or more selected from the group consisting of poly(meta-phenylene isophthalamide), 4,4-diaminodiphenylsulfone and 3,3-diaminodiphenylsulfone, without being limited thereto.

The polymer may be a polyamide in which an at least 85% amide bond (—CO—NH—) directly binds to two aromatic rings and may be used. In addition, another polymeric material, in an amount of about 10 wt % or less of polyamide, may be blended. In other words, about 10% of each of diamine of the aramid or diacid chloride of the aramid may be substituted by another substituent for polymerization. In addition, the polymer is preferably a meta-aramid, more preferably, a poly(meta-phenylene isophthalamide) polymer.

In addition, the aramid fabric may include an aramid fiber, preferably one or more selected from meta-aramid and para-aramid. In addition, the aramid fiber may be 1.0 D to 5.0 D (denier), preferably 2.0 D to 3.0 D (denier). In this case, when the aramid fiber has a fineness less than 1.0 denier, there may be problems of difficulty in making fabrics and reduced strength of fabrics, and when the aramid fiber has a fineness exceeding 5.0 denier, there may be a problem of difficulty in dipping a solution due to excessive thickness. In addition, the aramid fabric may be woven in a variety of forms which can be easily made by those skilled in the art, preferably one or more forms selected from plain weave, twill weave, satin weave and double weave, more preferably plain weave. When the aramid fabric is woven in the form of a plain weave, advantageously, the aramid fabric is thin, rigid and strong due to many woven marks, the solution easily permeates between woven fabrics, thus practical applicability, and various and modified fabrics can be obtained.

In addition, during the laminating and pressing, the crude aramid liquid-coated aramid fabric may be laminated in one or more layers, the number of layers is not particularly limited and the lamination may be suitably carried out in consideration of thickness and pressing process of the heat-resistant composite material to be produced.

In addition, the pressing may be carried out at a temperature of 300° C. or greater and at a pressure of 300 MPa or greater, preferably at a temperature of 300° C. to 400° C. and at a pressure of 300 MPa to 500 MPa.

In addition, after pressing and before drying, hot forming may be further performed. The highly heat-resistant composite material can be produced in a desired form by hot forming. In this case, hot forming is not particularly limited and may be carried out using a method generally used in the art. In a preferred embodiment, for forming a car tail trim, hot forming may be carried out at a temperature of 100° C. to 200° C. and at a 100 to 200 ton hydraulic press pressure for 30 to 120 seconds.

In addition, the drying may be carried out by heating at a temperature of 250° C. to 350° C., preferably 280° C. to 330° C. When the drying temperature is less than 250° C., the crude aramid liquid may be incompletely cured and there may be a problem of excessively long curing time and when the drying temperature exceeds 350° C., economic efficiency is less. Thus, the drying is preferably within the temperature range defined above.

The highly heat-resistant composite material of the present invention can be produced according to the method described above. When the produced highly heat-resistant composite material is applied to a material for car tail trims, an average thickness is not particularly limited and is preferably 1,000 μm to 2,000 μm, more preferably 1,200 μm to 1,800 μm.

Hereinafter, the present invention will be described with reference to examples in more detail. However, these examples are provided for illustration of the present invention and should not be construed as limiting the scope of the present invention.

### EXAMPLE

### Preparation Example 1

### Preparation of a Crude Aramid Liquid

With respect to 100 parts by weight of metaphenylene diamine, 1,000 parts by weight of N-methyl-2-pyrrolidone, 100 parts by weight of terephthaloyl chloride and 3 parts by weight of calcium chloride were mixed, sol-gel reaction (and/or polymerization) was conducted at a temperature of 25° C. under the atmosphere of nitrogen for 3 hours, and neutralization was conducted by adding 20 parts by weight of calcium hydroxide thereto with respect to 100 parts by weight of the aromatic diamine, to prepare a crude liquid containing an aramid polymer represented by the following Formula 2-1.

Then, 5 parts by weight of carbon black (production company: CABOT, trade name ELFTEX® 70) was mixed with 100 parts by weight of the crude liquid to prepare a crude aramid liquid.

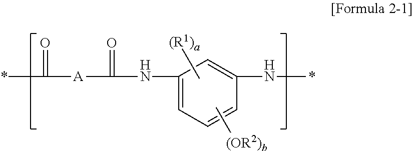

wherein A was

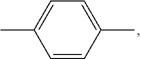

and a and b were zero.

The produced aramid polymer had a weight average molecular weight of 193,000.

### Preparation Example 2

A crude aramid liquid was prepared in the same manner as in Preparation Example 1, except that a crude aramid liquid containing an aramid polymer represented by the following Formula 2-2 was prepared by using isophthaloyl chloride instead of terephthaloyl chloride,

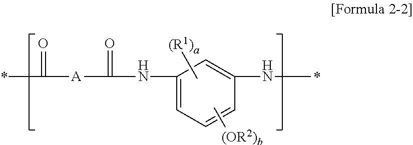

wherein A was

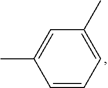

and a and b were zero.

The produced aramid polymer had a weight average molecular weight of 205,000.

### Preparation Example 3

A crude aramid liquid was prepared in the same manner as in Preparation Example 1, except that the crude aramid liquid was prepared by mixing 3 parts by weight of nanoclay instead of carbon black.

### Preparation Example 4

A crude aramid liquid was prepared in the same manner as in Preparation Example 1, except that the crude aramid liquid was prepared by mixing carbon black in an amount of 1 part by weight.

### Preparation Example 5

A crude aramid liquid was prepared in the same manner as in Preparation Example 1, except that the crude aramid liquid was prepared by mixing carbon black in an amount of 10 parts by weight.

### Preparation Example 6

A crude aramid liquid was prepared in the same manner as in Preparation Example 1, except that a crude liquid containing an aramid polymer represented by the following Formula 2-3 was prepared by using 5-ethylbenzene-1,3-diamine instead of metaphenylene diamine.

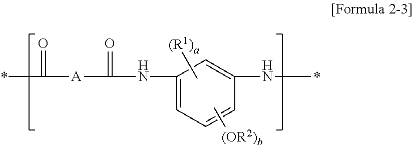

wherein A is

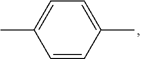

a was 1, R¹ is an ethyl group, and b was 0.

The produced aramid polymer has a weight average molecular weight of 188,000.

### Comparative Preparation Example 1

A crude aramid liquid was prepared in the same manner as in Preparation Example 1, except that carbon black was not used.

### Comparative Preparation Example 2

A crude aramid liquid was prepared in the same manner as in Preparation Example 1, except that the crude liquid containing an aramid polymer was prepared by conducting sol-gel reaction at a temperature of 60° C.

### Example 1

### Preparation of Composite Material

(1) Preparation of Aramid Fabric

Meta-aramid fibers having a fineness of 2.0 denier were plain-woven to produce a meta-aramid fabric layer. The produced fabric layer had an average pore size of 100 μm and an average thickness of 420 μm.

(2) Production of Composite Material

The produced aramid fabric was dipped in the crude aramid liquid prepared in Preparation Example 1 at a temperature of 25° C. for 5 minutes and dried at a temperature of 310° C. to produce an aramid composite including the aramid fabric provided with a crude aramid liquid cured layer.

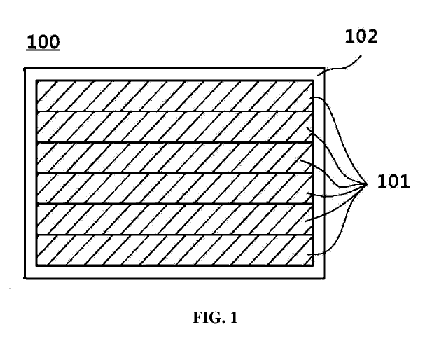

Then, five pieces of the produced functional aramid composites were laminated and pressed with a calender roll to produce a composite material with a thickness of 1.0 mm as shown in the schematic view of FIG. 1.

Then, the composite material was hot-formed at a temperature of 160° C. and at a 130 ton hydraulic press pressure for 500 seconds to produce a car tail trim.

### Examples 2 to 6 and Comparative Examples 1 to 2

Composite materials were produced in the same manner as in Example 1 using crude aramid liquids prepared in Preparation Examples 2 to 6 and Comparative Preparation Examples 1 to 2 instead of the crude aramid liquid of Preparation Example 1, and Examples 2 to 6 and Comparative Examples 1 to 2 were then conducted.

### Test Example 1

### Measurement of Physical Properties of Composite Material

Physical properties of composite materials prepared in Examples 1 to 6 and Comparative Examples 1 to 2 were measured in accordance with the following method.

1) Compressive Strength and Compressive Modulus

Deformation resilience of a plastic was measured upon compression of a predetermined load, and compressive strength and compressive modulus are shown in the following Table 1.

2) Tensile Strength and Tensile Modulus

Tensile strength and tensile modulus were measured using Instron equipment and are shown in the following Table 1.

3) Surface Strength

Surface strength was measured using a durometer and is shown in the following Table 1.

4) Heat Deflection Temperature

Heat deflection temperature was measured using a DMA system and is shown in the following Table 1.

5) Evaluation of Formability

Evaluation of formability was conducted by observation of surface defects and the overall shape of car tail trims produced by a group of ten specialists and was based on an average of scores evaluated by them.

[Criteria for Formability Evaluation]

100 to 95: very excellent

95 to 90: excellent

90 to 85: average

Less than 85: defective

TABLE 1

| | | | | | | Heat | |
|---|---|---|---|---|---|---|---|
| | Compressive | Compressive | Tensile | Tensile | Surface | deflection | |
| | strength | modulus | strength | modulus | strength | temperature | Evaluation of |
| Items | (Mpa) | (Mpa) | (Mpa) | (Mpa) | (D Type) | (° C.) | formability |
| Example 1 | 88.5 | 660.1 | 78.3 | 2532.6 | 96 | 347.9 | Very |
| | | | | | | | excellent |
| Example 2 | 82.4 | 625.7 | 80.5 | 2613.4 | 95 | 326.3 | Very |
| | | | | | | | excellent |
| Example 3 | 87.2 | 651.3 | 79.1 | 2546.5 | 95 | 339.6 | Very |
| | | | | | | | excellent |
| Example 4 | 86.4 | 646.5 | 80.4 | 2566.6 | 95 | 338.7 | Very |
| | | | | | | | excellent |
| Example 5 | 90.3 | 672.7 | 75.8 | 2502.1 | 97 | 354.6 | Very |
| | | | | | | | excellent |
| Example 6 | 87.3 | 655.7 | 78.9 | 2540.3 | 95 | 344.2 | Excellent |
| Comparative | 84.3 | 634.4 | 80.9 | 2578.2 | 95 | 332.1 | Very |
| Example 1 | | | | | | | excellent |
| Comparative | 91.8 | 681.9 | 70.3 | 2418.7 | 95 | 350.5 | Average |
| Example 2 | | | | | | | |

As can be seen from test results of Table 1, all of the composite materials produced in Examples 1 to 6 exhibited excellent overall mechanical properties as well as excellent heat resistance at a temperature of 300° C. or greater.

However, Comparative Example 1 in which an inorganic substance was not used exhibited poor mechanical properties such as compressive strength, as compared to Examples.

In addition, Comparative Example 2 in which sol-gel reaction was conducted at a temperature of 60° C., which was greater than 40° C., exhibited excellent overall physical properties, but exhibited low formability as compared to Examples. In addition, Comparative Example 2 exhibited poor tensile strength and tensile modulus as compared to Example 1.

It can be seen that highly heat-resistant composite materials produced in Example and Test Example by the method suggested by the present invention were excellent and car tail trims which were conventionally produced with metal materials are expected to be provided as lightweight materials according to the present invention.

### REFERENCES IN DRAWING

100: highly heat-resistant composite material
101: aramid fabric
102: cured layer

1. A highly heat-resistant composite material comprising:
an aramid fabric; and
a coating layer coating partially or entirely the aramid fabric,
wherein the coating layer is a cured layer of a coating agent comprising an aramid polymer having a repeat unit represented by the following Formula 2: 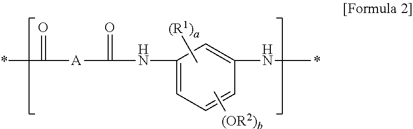
wherein A is 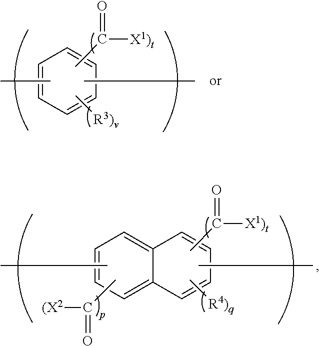
R¹ and R² are each independently a C1-C5 alkyl group, R³ and R⁴ are each independently a hydrogen atom or a C1-C4 alkyl group, X¹ and X² are each independently —F, —Cl, —Br or —I, and a, b, p, q, t and v are each independently an integer of 0 to 2.

2. The highly heat-resistant composite material according to claim 1, wherein A is 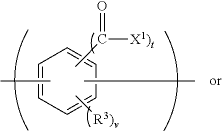
wherein R³ is a hydrogen atom or a C1-C2 alkyl group, X¹ is —F, —Cl, —Br or —I, and t and v are each independently an integer of 0 to 1.

3. The highly heat-resistant composite material according to claim 1, wherein the aramid polymer has a weight average molecular weight of 5,000 to 500,000.

4. The highly heat-resistant composite material according to claim 1, wherein the coating agent further comprises 0.1 to 20 parts by weight of an inorganic substance with respect to 100 parts by weight of the aramid polymer.

5. The highly heat-resistant composite material according to claim 4, wherein the inorganic substance comprises one or more selected from the group consisting of glass fiber, SiO₂, TiO₂, graphene, carbon nanotube (CNT), carbon black and nanoclay.

6. The highly heat-resistant composite material according to claim 1, wherein the coating agent further comprises one or more solvents selected from the group consisting of N-methyl-2-pyrrolidone, dimethylformamide, dimethyl sulfide and dimethylacetamide.

7. The highly heat-resistant composite material according to claim 1, wherein the highly heat-resistant composite material has an average thickness of 1,000 to 2,000 μm.

8. A method for producing the highly heat-resistant composite material according to claim 1 comprising:
preparing an aramid monomer represented by the following Formula 2 by coupling one or more aromatic diamines represented by the following Formula 1 and aromatic diacid chloride in the presence of a catalyst comprising one or more selected from calcium chloride and lithium chloride, and a solvent; and
preparing a crude aramid liquid by stirring the aramid monomer and the solvent to prepare a mixture and conducting sol-gel reaction of the mixture at a temperature of 0° C. to 40° C. under the atmosphere of nitrogen (N₂), 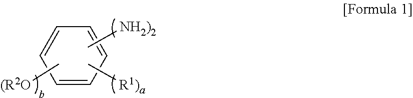
wherein R¹ and R² are each independently a C1-C5 alkyl group, and a and b are each independently an integer of 0 to 2, and 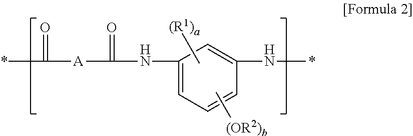
wherein A is each independently 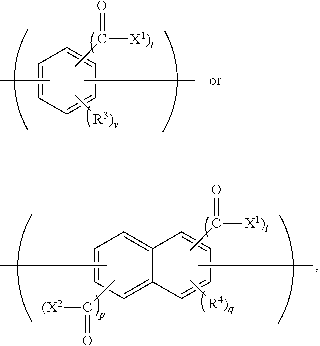
R¹ and R² are each independently a C1-C5 alkyl group, R³ and R⁴ are each independently a hydrogen atom or a C1-C4 alkyl group, X¹ and X² are each independently —F, —Cl, —Br or —I, and a, b, p, q, t and v are each independently an integer of 0 to 2.

9. The method according to claim 8, further comprising:
coating partially or entirely the aramid fabric with the crude aramid liquid;
laminating and pressing the crude aramid liquid-coated aramid fabric; and
drying the resulting aramid fabric.

10. The method according to claim 8, wherein A is 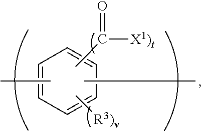
wherein R³ is a hydrogen atom or a C1-C2 alkyl group, X¹ is —F, —Cl, —Br or —I, and t and v are each independently an integer of 0 to 1.

11. The method according to claim 8, wherein the aromatic diacid chloride comprises one or more selected from the group consisting of trimesoyl chloride, naphthalene-2,7-dicarbonyl chloride, naphthalene-2,6-dicarbonyl chloride, isophthaloyl chloride and terephthaloyl chloride.

12. The method according to claim 8, wherein the solvent for preparation of the aramid monomer and preparation of the crude aramid liquid comprises one or more selected from the group consisting of N-methyl-2-pyrrolidone, dimethylformamide, dimethyl sulfide and dimethylacetamide.

13. The method according to claim 8, wherein the aromatic diacid chloride is present in an amount of 95 to 105 parts by weight and the catalyst is present in an amount of 1 to 10 parts by weight, with respect to 100 parts by weight of the aromatic diamine.

14. The method according to claim 8, wherein the mixture during sol-gel reaction comprises 400 to 1,900 parts by weight of the solvent, with respect to 100 parts by weight of the aramid polymer.

15. The method according to claim 14, wherein the mixture further comprises 0.1 to 20 parts by weight of an inorganic substance, with respect to 100 parts by weight of the aramid polymer.

16. The method according to claim 15, wherein the inorganic substance comprises one or more selected from the group consisting of glass fiber, SiO₂, TiO₂, graphene, carbon nanotube (CNT), carbon black and nanoclay.

17. A car tail trim comprising the highly heat-resistant composite material according to claim 1.
